(19) United States
(12) Patent Application Publication
(10) Pub. No.: US 2022/0261957 A1
(43) Pub. Date: Aug. 18, 2022

(54) STITCH IMAGES

(71) Applicant: Pricer AB, Stockholm (SE)

(72) Inventors: Nils HULTH, Stockholm (SE); Bjorn NILSSON, Stockholm (SE)

(73) Assignee: Pricer AB, Stockholm (SE)

(21) Appl. No.: 17/624,684

(22) PCT Filed: Jul. 8, 2020
(86) PCT No.: PCT/EP2020/069313

§ 371 Date: Jan. 4, 2022

(30) Foreign Application Priority Data
Jul. 9, 2019 (SE) 1950875-3

(51) Int. Cl. G06T 3/40; G06T 7/73; H04N 5/232; H04N 5/247

(52) U.S. Cl. CPC G06T 3/4038; H04N 5/247; H04N 5/23232; G06T 7/73

(57) ABSTRACT

A method and system for stitching together a first image and a second image of a retail environment are provided. The position of an electronic label is detected in a first and a second set of reference images based on changes of optical output of the electronic label. The position of the electronic label in a first and a second image to be stitched together is then determined based on the determined position of the electronic label in the reference images.

### TECHNICAL FIELD

This disclosure relates to methods for stitching images captured by a first and a second camera.

### BACKGROUND

A common way of providing images larger than the field of view of the camera or cameras used is combining or stitching images into a larger image wherein the images have overlapping field of view. The resulting stitched image can include a larger field of view and more image data than each individual image. Generating a stitched image using one or more cameras can be more cost-effective than capturing a single image using a camera with a similar field of view, i.e. acquire image data using a higher-resolution and/or higher-performance camera.

In the prior art, location within an image of shelves in a retail environment has been based on object recognition analysis. Typically, when stitching images, image analysis techniques using edge detection algorithms or similar are used to identify characteristic features or whole objects in images such as relatively long, continuous edges within the images. Algorithms are then used to identify these features to be the same in two or more images. This often results in demanding image processing, and hence there is a need for an improved method for stitching images.

### SUMMARY OF THE INVENTION

It would be advantageous to achieve a method for stitching images overcoming, or at least alleviating, the above mentioned drawback. In particular, it would be desirable to provide efficient stitching of images, i.e. decrease the amount of computer processing needed to provide a proper stitching of images.

To better address one or more of these concerns, a method and a system for stitching images having the features defined in the independent claims are provided. Preferable embodiments are defined in the dependent claims.

Hence, according to an aspect, a method is provided for stitching images of a retail environment by stitching a first image and a second image, wherein the first image and the second image comprise an electronic label having an optical output. The method comprises controlling the electronic label to change its optical output, wherein the changes of optical output of the electronic label include a temporal pattern of optical changes. The method may comprise receiving a first set of reference images related to the first image, the images in the first set of reference images comprising the electronic label and captured by a first camera at points in time such that the temporal pattern of optical changes is detectable in the images in the first set of reference images. The method may comprise determining the position of the electronic label in the images in the first set of reference images based on a detected temporal pattern of optical changes. The method may further comprise receiving a second set of reference images related to the second image, the images in the second set of reference images comprising the electronic label and captured by a second camera at points in time such that the temporal pattern of optical changes is detectable in the images in the second set of reference images. The method may comprise determining the position of the electronic label in the images in the second set of reference images based on a detected temporal pattern of optical changes. The method may also comprise determining the position of the electronic label in the first and second images based on the determined position of the electronic label in the first and second sets of reference images and stitching the first and second image by using the determined positions of the electronic label in the first and second images as reference points.

By stitching images, it is meant combining images for the purpose of creating a larger image containing features from all the images being combined, i.e. increasing the image to include the field of view of all the images combined. An improved accuracy in stitching images may provide an improved resulting stitched image. It is therefore desirable to have the images combined in a correct way in order to reduce the amount of artifacts in an image that may be the result of stitching or combining images.

By reference points it may be meant stitching points or tie points, i.e. points in at least two images depicting the same spatial feature.

By stitching the first and second images by using the determined positions of the electronic label in the first and second images as reference points it may be meant that the first and second images are stitched together by overlapping the two images such that the position of the electronic label in the first image is aligned with the position of the electronic label in the second image.

A retail environment may for example be any environment wherein products or goods, services or similar are offered for selling or rental purposes to customers or potential customers. By products it may be meant items (e.g. retail items) or a category of items (e.g. category of retail items), for example a certain product unit or a product type.

An electronic label having an optical output means an electrically powered label with the capability of altering its output or appearance. The output may be a display, light emitting diode (LED) or any other visual device. The display may contain information associated with a related service or item (such as a product unit). An associated product may be located relatively close to the electronic label in order for the electronic label to be relatable to the product of interest.

By including a temporal pattern of optical changes in the output of the electronic label it is meant that the output of the electronic label is changed over time, wherein the electronic label may have a light source such as a display, LED or other visual device that has an optical output that can be changed accordingly. The output may have alternating colors. The output may be a fast alternating light, i.e. fast blinking, such as flashing light or a slow alternating light forming a pulsing light, i.e. slow blinking, or anywhere in between slow and fast alternating outputs. By fast is here meant that the output of the display may be altered and thus distinguished between two or more subsequent recorded images of the label. Slow is in this context referring to that the output of the display may be changed so that the change in output is distinguishable after a plurality of frames of the recording. Typically, a camera working in the range between 1 to 250 frames per second (fps) may be used. The change of optical output of the label may combine different lengths of blinking and/or color so that a pattern characteristic for a specific label is achieved when recording images of the label.

By determining the position of the electronic label in the first and second image based on the determined position of the electronic label in the first and second sets of reference images it is meant that the position of the electronic label, i.e. the coordinates for the position of the electronic label, in the first and second reference images are used to determine the position of the electronic label, e.g. position of the electronic label expressed in coordinates in the first and second image. There may be a know relationship between the first image and the first set of reference images, and between the second image and the second set of reference images, providing a facilitated determination of the position of the electronic label in the first and second image based on the determined position of the electronic label in the first and second sets of reference images.

A set of reference images refers to more than one image captured by a camera. The set of reference images is preferably a series of images. The images in a set may have a similar field of view. The same camera will typically be used for capturing both the set of reference images and the image to which the reference images relate. The capturing of the set of reference images may be performed separated in time from the capturing of the image it is relating to. The separation in time between capturing the set of reference images and the related image may be short, e.g. the set of reference images and the related image may be captured in a sequence, or the set of reference images and the related image may be captured at different times during the day. The images in the set of reference images may be used to distinguish changes in optical output of the electronic label. The set of reference images may be captured in a light setting facilitating distinguishing the change in optical output, i.e. a light setting wherein the visibility of the optical output in relation to the ambient light is improved, and hence an improvement of the detectability in the changes of optical output may be provided. This could be in a light setting wherein the ambient light is relatively dark, for example surrounding lights may be switched off or dimmed to a low intensity mode. The image relating to the set of reference images may be used for stitching. The image relating to the set of reference images may be captured in normal light setting. In other words, the image relating to the set of reference images may be captured in an everyday light setting or a light setting with proper illumination, i.e. a light setting facilitating imaging of the environment.

By the first set of reference images related to the first image it is meant that the set of reference images and the related image have been captured using a camera with the same field of view. Hence, a stationary object depicted in both the set of reference images and the image related to the set of reference images may appear at the same position in the images.

By including a temporal pattern of optical changes in the output of the electronic label, identification of an electronic label in a set of reference images is facilitated. An electronic label can thus be identified as a common feature in two separate sets of images and their respective related image using less computer processing power based on the characteristic change in optical output of the electronic label. The change in optical output may comprise binary optical output signals from the electronic labels. This will in turn facilitate the combining, or stitching, of two overlapping images related to the first and second set of reference images, i.e. facilitate the stitching of the first and second image, where the first and second image are related to the first set and second set respectively.

By binary optical output it is meant an optical output changing over time by either being switched on or off, i.e. either generating light or not. This may be in a characteristic pattern unique for each electronic label.

By determining the position of the electronic label in the images of the second set of reference images based on a detected temporal pattern of optical changes, it is meant distinguishing and/or detecting the temporal pattern of optical changes in the output from an electronic label seen in an image. The distinguished and/or detected temporal pattern of optical changes may be compared to a set of known patterns of optical changes for a set of electronic labels. For example, an electronic label viewed in a set of reference images may be associated with a certain temporal pattern of optical changes being detected and thus the identity of the specific electronic label may be determined. Hence, the position of an electronic label in the set of reference images may be determined, wherein the identity of the electronic label is known. From the determined position of the electronic label in the images a position of the electronic label in the environment may be determined, i.e. a spatial position. This spatial position may be a relative position or an absolute position. The determination of position of electronic labels may, for example, be performed as described in EP 3154009 A1.

By stitching the first and second image based on the position of the electronic label in the first and second set of reference images it is meant that the determined position of the electronic label in the reference images may be used to determine coordinates or a position in the related first and second image depicting the electronic label. In other words, by knowing the position of the electronic label in the first and second set of reference images, the coordinates in the first and second set of reference images and in the related first and second image respectively are given, and thus suitable to be used when stitching the first and second image together. The position of the electronic labels in the images may be used to stitch the first and the second image. The position of the electronic labels in the images may be defined, for example, by coordinates in the first and second image, respectively, depicting the same features. More than one electronic label may be used to provide additional coordinates to further facilitate stitching of the first and second image. The first and second set of reference images are captured using a first and second camera having an overlapping field of view.

According to an embodiment, the method comprises detecting the distinct temporal patterns of optical changes in the first set of reference images by analyzing the first set of reference images, and detecting the distinct temporal patterns of optical changes in the second set of reference images by analyzing the second set of reference images. The determining of the position of the electronic label in the first and second sets of reference images may be based on the distinct temporal patterns of optical changes detected in the respective first and second sets of reference images.

By detecting the distinct temporal patterns of optical changes by analyzing the first set of reference images it is meant that patterns of optical output from the electronic labels are detected. A pattern may be detected by comparing more than one change of optical output from the electronic label to known patterns and/or comparing a detected single change of optical output from the electronic label to known points in time where a change of optical output is expected for a certain electronic label. Examples of changes of optical output are a change in an on/off state of an optical device of the electronic label, a change in light intensity from an optical device of the electronic label, a light pulse, a flashing light, and or a change in color. An optical device may be, for example, a light source such as a lamp, light emitting diode (LED), display or another visual device. This may facilitate the determination of the position of a certain electronic label in an image and thus facilitates the determination of points in two or more images depicting the same physical feature and may further facilitate the stitching of two or more images.

According to an embodiment, the electronic label is associated with an item (e.g. a retail item) and the determined position of the electronic label is associated with a position of said item in the images. From the determined position of the electronic label in the images, a position of the electronic label in the environment may be determined, i.e. a spatial position. Hence, a spatial position associated with the item may be determined. By the electronic label being associated with an item is meant that the information displayed on the electronic label is referring to this item. The electronic label may be arranged in the vicinity of the item. For example, the item may be located on the shelf on which the electronic label is arranged. The distance between the item and its related electronic label may be shorter than the distance between the item and other electronic labels. The electronic label may be aligned to the left or right of the item or items it is associated with. The electronic label may be on or above the shelf on which the item or items are located. The electronic label may be associated with an area of a shelf on which a group of items may be arranged.

According to an embodiment, the method further comprises determining the position of said first camera based on the first image or determining the position of said second camera based on the second image.

Determining the position of said first or second camera based on the first or second image means that information in the captured image is used to determine the positon of the camera capturing the image, e.g. a first camera capturing the first image and a second camera capturing the second image. By position of a camera it is in this context meant the spatial position, i.e. the position within an environment such as a retail environment. By knowing the position, i.e. location of the camera, less computing power may be required when processing data since the known camera location may facilitate an initial selection of cameras to use, i.e. which images to use when selecting images to be stitched together.

According to an embodiment, the determination of the position of said first or second camera is based on a reference object comprised in the first or second image.

A reference object may be an identifiable and/or known object with known position. For example the reference object may be a QR-code, a symbol, a number and/or letter. The reference object may be a sign or a display arranged to have its optical output changed. The reference object may contain information about its position visually communicated to the camera. For example, a QR code may contain information related to the position of the reference object. The position of the reference object may be determined by comparing the identified reference object to a list of known positions for each reference object or by directly reading from the information provided by the reference object. For example, a look-up table may be used to determine the position of the reference object after it has been identified. The above embodiments may provide a facilitated determination of the position of the cameras.

According to an embodiment, the first image may be captured by the first camera and the second image may be captured by the second camera.

By capturing the first image using the same camera as when capturing the first set of reference images and by capturing the second image using the same camera as when capturing the second set of reference image a facilitated detection of the position of the electronic labels within the first and second images may be provided since the same field of view of the camera may be used. Alternatively, changed camera settings, e.g. changes in roll, tilt, yaw and/or zoom may be tracked and/or changed in a predetermined way affecting the field of view, wherein the change in field of view may be taken into account when detecting the position of the electronic label within the first and second images based on the position of the electronic label within the first and second sets of reference images.

According to an embodiment, the method further comprises generating a map over at least a portion of the retail environment based on the stitched images and the determined position of the electronic label. This may provide a facilitated determination of the position of items in a retail environment. It may facilitate restocking of specific items and/or facilitate for a customer to find to the desired items. It may also provide the customer with information about item availability. This may also facilitate guiding the customer to a desired position in the retail environment.

According to an embodiment the map is generated based on a reference object comprised in the first or second image. This may facilitate generating a map. For example, there may be more than one pair of images stitched together. A reference object may facilitate determining the relative position of each stitched image.

According to an embodiment the generated map is a three-dimensional map. This may provide a facilitated determination of the position of items in a retail environment. It may facilitate restocking of specific items and or facilitate for a customer to find to the desired items. It may also provide the customer with information about item availability, i.e. information about stock. This may also facilitate guiding the customer to their desired position in the retail environment.

According to an embodiment the controlling of the electronic label is performed in response to a first control signal from a processing unit and the images are captured by said first or second camera in response to a second control signal from the processing unit. This provides facilitated functionality by enabling controlled timing of the image capturing with the controlled output from the electronic labels and hence further facilitates detection of the distinct temporal patterns of optical output from the electronic labels. By controlling the output of the electronic label and the camera capturing images, the optical output of the electronic label may be changed such that the detection of optical changes by the camera capturing images is facilitated, i.e. image capturing and the optical output of the electronic label may be timed in order to further increase detectability of the optical changes.

According to an embodiment the second image comprises a second electronic label and a third image comprises the second electronic label, the method further comprises receiving a third set of reference images related to the third image, the images in the third set of reference images comprising the second electronic label and being captured by a third camera at points in time such that a second temporal pattern of optical changes is detectable in the images in the third set of reference images, determining the position of the second electronic label in the images in the second set of reference images based on a detected temporal pattern of optical changes and determining the position of the second electronic label in the images in the third set of reference images based on a detected temporal pattern of optical changes, and determining the position of the electronic label in the second and third images based on the determined position of the electronic label in the first and second sets of reference images and stitching the third image with the second image by using the determined positions of the electronic label in the second and third images as reference points.

The third set of reference images may overlap either the first set of reference images or the second set of reference images. The third set of reference images may overlap both the first set of reference images and the second set of reference images. The third image may overlap either the first image or the second image. The third image may overlap both the first image and the second image. The overlap of the third image to the first and/or the second image may be a partial and/or complete overlap. The overlap of the third set of reference images to the first and/or the second set of reference images may be a partial and/or complete overlap. By having a third set of reference images, the combined field of view of the stitched image originating for the first, second and third images may be wider, as compared to an image stitched of only two images.

According to an embodiment, the first image and the second image each comprises a plurality of electronic labels, for example 2 or 3 or more, and the first and the second set of reference images each comprises the electronic labels. The method may further comprise controlling the electronic labels to change their respective optical output, wherein the respective changes of optical output of the electronic labels include a temporal pattern of optical changes and determining the respective positions of the electronic labels in the images in the first set of reference images based on a detected temporal pattern of optical changes and determining the respective positions of the electronic labels in the images in the second set of reference images based on a detected temporal pattern of optical changes and stitching the first and second image based on the position of the electronic labels in the first and second set of reference images.

A plurality of electronic labels will further facilitate stitching the first and second image since there are more points known to identify the corresponding features in the first and second image. The optical output may facilitate determining the position of a group of electronic labels. With increasing number of electronic labels captured in both the first and second set of reference images there may be fewer images needed in the set of reference images in order to detect a certain group of labels. For example, a group of several electronic labels may change their optical output and the group of electronic labels may be identified in both the first and second image.

According to a second aspect, a system for stitching images is provided. The system comprises an electronic label arranged to change its optical output, a first camera for capturing a first set of reference images comprising the electronic label, a second camera for capturing a second set of reference images comprising the electronic label and a processing unit for performing the method described above.

According to an embodiment the electronic label is arranged on a shelf.

According to an embodiment the first camera is arranged on a first shelf, in a ceiling or a wall and the second camera is arranged on a second shelf, in a ceiling or a wall.

According to an embodiment the system comprises a reference object associated with a shelf. This may provide facilitated determination of the position of the cameras and the electronic labels based on known position of the reference objects. It may also reduce requirements on data processing power when processing data since the reference object may facilitate the selection of possible images that are suitable to stitch together.

A shelf may be a regular shelf, shelf unit, rack or some other type of arrangement for storing items (e.g. retail items, such as products) in a retail store. A shelf may be a shelf unit comprising of multiple shelves, e.g. a gondola, a product shelf, similar to that of a bookcase, that may carry multiple products arranged on more than one level, or a single shelf. The single shelf may be a single shelf mounted on a wall or in a stand or a shelf within a shelf unit, wherein the shelf unit comprises several shelves.

It is noted that embodiments of the invention relate to all possible combinations of features recited in the claims. Further, it will be appreciated that the various embodiments described for the device are all combinable with the method as defined in accordance with the second aspect of the present invention.

### BRIEF DESCRIPTION OF THE DRAWINGS

These and other aspects will now be described in more detail in the following illustrative and non-limiting detailed description of embodiments, with reference to the appended drawings.

FIG. 1 shows an overview of the system for stitching images according to an embodiment.

FIG. 2 shows a perspective view from above of an environment of the system setup with two cameras having an overlapping field of view of shelf units according to an embodiment.

FIG. 3 shows two sets of images captured by two cameras having an overlapping field of view.

FIG. 4 shows two images captured by two cameras with a partly overlapping field of view having a plurality of electronic labels in the overlapping field of view.

FIG. 5 shows three images captured by three cameras with partly overlapping fields of view stitched together into one image.

FIG. 6 shows an electronic label on a shelf with an associated item captured by two cameras.

FIG. 7 shows a 2D map of shelf units from the front based on at least two images being stitched together.

FIG. 8 shows a 2D map of shelf units viewed from above based on at least two images stitched together.

FIG. 9 shows a 3D map of a retail area.

FIG. 10 shows a flow chart of the method according to an embodiment.

FIG. 11 shows a flow chart of the method according to an embodiment.

All the figures are schematic, not necessarily to scale, and generally only show parts which are necessary in order to elucidate the embodiments, wherein other parts may be omitted. Like reference numerals refer to like elements throughout the description.

### DETAILED DESCRIPTION OF EMBODIMENTS

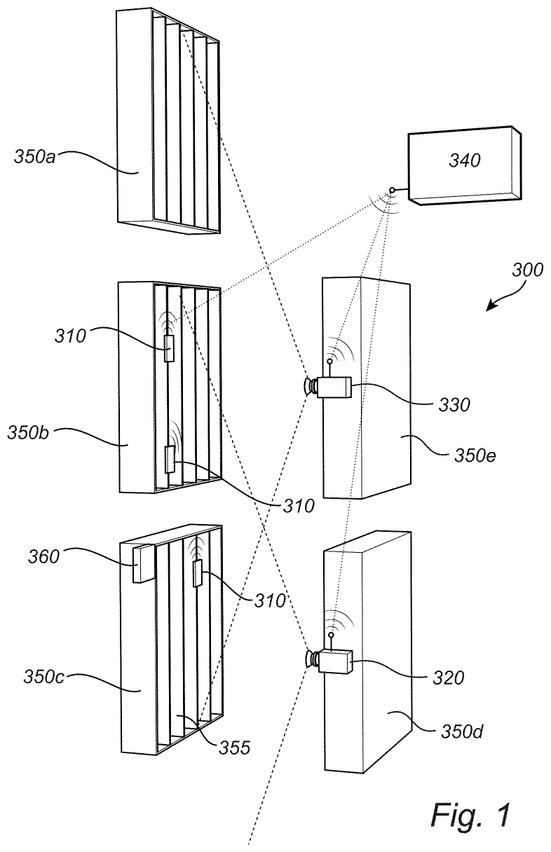

A system 300 for stitching images according to an embodiment will be described with reference to FIG. 1. The system 300 in FIG. 1 comprises an electronic label 310 arranged to change its optical output, a first camera 320 for capturing a first set of reference images comprising the electronic label 310, a second camera 330 for capturing a second set of reference images comprising the electronic label 310, and a processing unit 340 for performing the method according to embodiments described hereinafter.

The first and/or second camera 320;330 may be arranged on or in a shelf. The shelf may be a single shelf 355 or a shelf unit 350a-e comprising several shelves. In other words, the first and/or second camera 320;330 may be arranged on or in a shelf unit 350a-e comprising several shelves 355 or, on a single shelf 355. The single shelf 355 may be arranged within a shelf unit 350a-e. The shelf unit 350a-e may also be referred to as a gondola comprising a flat base and a vertical component for holding several shelves 355.

The first camera 320 may be arranged on a first shelf and the second camera 330 may be arranged on a second shelf. As seen in FIG. 1, the first camera 320 may be arranged on a first shelf unit 350d and the second camera 330 may be arranged on a second shelf unit 350e.

The electronic label 310 may also be arranged on a shelf. The electronic labels 310 may be arranged on shelves of a shelf unit 350. As illustrated in FIG. 1, the electronic label 310 may be arranged on a third shelf unit 350a-350c. The third shelf unit 350a-350c may be at least partly within the field of view of the first and second camera 320,330, respectively, so that the images captured by the first and second cameras 320,330 comprise the electronic label 310. In other words, the first and second cameras 320; 330 have overlapping fields of view and the electronic label 310 is contained within both fields of view. The shelf, on which the electronic label 310 may be arranged, may be at least partly viewed by the first and second cameras 320;330. FIG. 1 depicts three electronic labels 310, however the system 300 may comprise only one electronic label 310 or the system 300 may comprise a plurality of electronic labels 310. The system 300 may be arranged in a retail environment and the electronic label/s 310 may be arranged on the edge of the shelf/shelves facing outwards towards an isle in the retail environment.

The first camera 320 and the second camera 330 for capturing a first and a second set of reference images comprising the electronic label 310 may be arranged on a shelf as is seen in FIG. 1. Additionally, or alternatively, cameras may be arranged in the ceiling and/or the walls of the retail environment or arranged in another way within the retail environment, for example on another object in the retail environment such that the electronic label 310 may be arranged in the field of view of the first camera 320 and the second camera 330.

The system 300 may comprise a plurality of cameras and/or a plurality of electronic labels 310. There may be a plurality of electronic labels 310 viewed by each camera 320;330 in the system. The system 300 may comprise a plurality of electronic labels 310 viewed by any two cameras. In other words, the first and second cameras 320;330 may be arranged so that a plurality of electronic labels 310 are within the field of view of the first and second cameras 320;330. The first and second cameras 320;330 may be arranged so that a plurality of electronic labels 310 are within an overlapping field of view of the first and second cameras 320;330. Each electronic label 310 may be associated with one or more items arranged next to the electronic label 310. The electronic label 310 may be arranged on a shelf, on top or below of which the item it is associated with is also arranged

The system 300 may comprise a reference object 360 associated with a shelf and/or a camera. By ‘associated with a shelf and/or camera’ it is meant that the reference object is related to the shelf and/or related to the camera. For example, the reference object 360 may have a known position relative to the associated shelf and/or the associated camera. This may for example provide a facilitated identification and/or determination of position of the associated shelf and/or camera when identifying the reference object 360, i.e. the associated shelf and/or camera may be identified and/or have its position determined based on the identification of the reference object 360. Further, the reference object 360 may have visual features facilitating determination of its position relative the camera. The visual features of the reference objects may have a predetermined shape and size. The visual features may be distorted and have different sizes when captured by the camera depending on the orientation of the camera relative the reference object, distance between the reference object, and the field of view of the camera, e.g. a zoom-setting of the camera and/or direction of the camera. Hence, based on a determined distortion and size, the camera orientation and position relative the reference object and thus the shelf may be determined. For example, by knowing the size of the visual features of the reference object and the zoom-setting of the camera, the distance between the camera and the reference object may be determined. By camera orientation it may be meant a roll, a pitch and/or a yaw setting of the camera capturing the image. The visual features may comprise a predetermined shape, such as a circle, an oval, a square, a rectangle or any shape suitable for determining a depicted distortion. The depicted distortion may be significant for the orientation of the camera. By distortion it may be meant a perspective distortion and/or a distortion affected by change in roll, pitch and/or yaw setting of the camera capturing the image, e.g. the depicted object may be skewed and/or rotated. The predetermined shape may be of a predetermined size.

For example, as seen in FIG. 1 the reference object 360 is associated with the shelf unit 350c. It should be understood that the reference object 360 may be associated with anyone of the shelf units 350a-c. Further, the reference object may be associated with one or more cameras. For example, as seen in FIG. 1, the reference object may be arranged in the field of view of the first and second cameras 320;330 and thus the reference object 360 may be associated with at least one of the first and second cameras 320;330. Hence, the reference object 360 may be associated with the camera that has a field of view that covers the reference object 360. The reference object 360 may be arranged in a predetermined position relative the associated shelf unit 350a-c and/or arranged in a predetermined position relative the associated first and/or second camera 320;330. As a non-limiting example, the reference object 360 may be arranged on, or in the shelf unit 350a-c. Alternatively the reference object 360 may be arranged hanging from the ceiling above the shelf unit 350a-c. Accordingly, the reference object 360 may facilitate determining the position of the camera capturing the image and/or the position of the depicted objects in the image by having a known position of the reference object relative to associated objects in the image and/or the camera capturing the image. Such objects in the image may for example be the shelf unit 350a-c, electronic labels and items arranged on the shelves. The reference object 360 may be a QR-code, a symbol, a number and/or letter. The reference object 360 may be a sign or a display arranged to have its optical output changed.

A shelf could for example refer to a shelf unit 350a-e comprising of several shelves 355, i.e. a product shelf, or a single shelf 355 within a shelf unit 350a-e. Hence, the electronic label 310 may be arranged on a shelf unit 350a-e, more precisely on a single shelf 355. The electronic label 310 may be arranged close to the same shelf unit 350a-e or close to the same single shelf 355 on which the item it is associated with, may be arranged. The item associated with the electronic label 310 may be arranged on the same shelf unit 350a-e or on the same single shelf 355 as the electronic label 310 is arranged.

The optical output may comprise a light emitting diode (LED) and/or a display. The display may comprise electronic paper, e-paper, electronic ink. e-ink, LCD, Oled, LCD TFT, electrophoretic or any other display devices capable of change its output electronically. The change in optical output may comprise alternating output of intensity from the electronic label and/or change in color output from the electronic label.

The processing unit 340 communicates with the electronic labels 310 and/or the cameras 320;330. The processing unit 340 may communicate with the cameras 320;330 and/or the electronic labels 310 using a wired connection or a wireless connection. The processing unit 340 may communicate with the cameras 320; 330 and/or the electronic labels 310 using light such as UV, visible light, and/or IR. UV light may typically range from 100 nm to 400 nm. Visible light may typically range from 380 nm to 740 nm. Infra-red light may typically range from around 700 nm to 1 mm. The processing unit 340 may communicate with the cameras 320; 330 and/or the electronic labels 310 using near-IR, which typically range from around 700 nm to 1400 nm. The processing unit 340 may communicate with the cameras 320; 330 and/or the electronic labels 310 using radio communication, i.e. electromagnetic waves of frequency between 30 hertz (Hz) and 300 gigahertz (GHz). The processing unit 340 may communicate with the cameras 320; 330 and/or the electronic labels 310 using sound using a loudspeaker and a microphone as a sender/receiver.

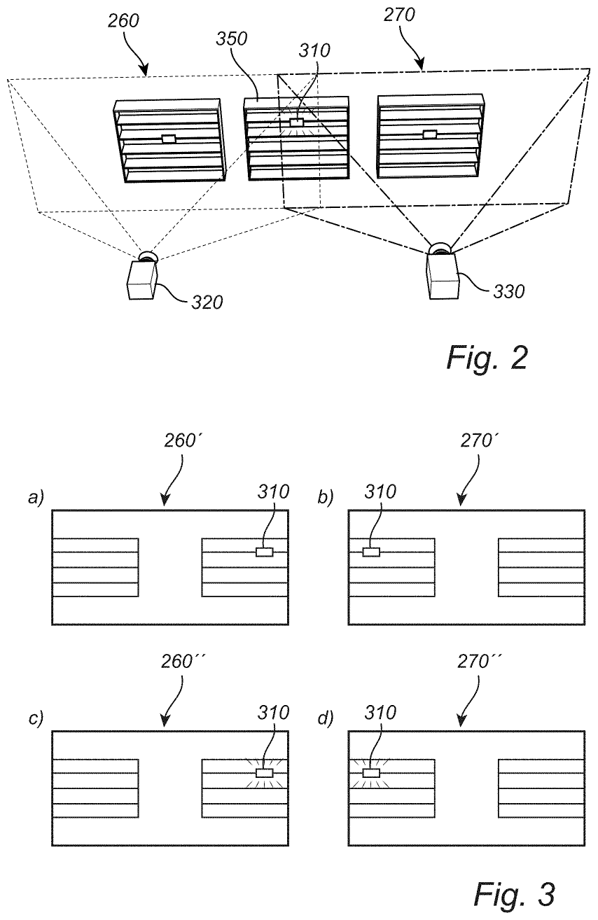

The processing unit 340 may be configured to perform any method 100 described with reference to FIGS. 2-11.

A method 100 for stitching images of a retail environment by stitching a first image and a second image, according to an embodiment will be described with reference to FIGS. 2-11.

As seen in FIG. 2, a first camera 320 may capture a first image 260 comprising at least one shelf unit 350. A plurality electronic labels 310 may be arranged in the at least one shelf unit 350 and captured by the first camera 320. At least part of the plurality of the electronic labels 310 captured by the first camera 320 may be arranged in the shelf unit 350 so that they are also viewed by a second camera 330 capturing a second image 270. In other words, at least one of the plurality of electronic labels 310 arranged in the at least one shelf unit 350 may be captured both by the first camera 320, i.e. depicted in an image captured by the first camera 320, and by the second camera 330, i.e. depicted in an image captured by the second camera 330.

Hence, the first and second cameras 320;330 may capture a first and a second image 260;270, respectively, wherein the first image 260 and the second image 270 at least partly overlaps, in other words, the first camera 320 and the second camera 330 may have overlapping fields of view. At least one electronic label 310 is within the field of view of both cameras, i.e. located in the overlap.

The first camera 320 in FIG. 2 may capture a first set of reference images 260′, 260″ seen in FIGS. 3a and 3c. The second camera 330 in FIG. 2 may capture a second set of reference images 270′,270″ seen in FIGS. 3b and 3d.

Hence, the first set of reference images 260′;260″ may be related to the first image 260 and the second set of reference images 270′;270″ may be related to the second image 270.

In other words, the first image 260 and the images in the first set of reference images 260′,260″ depict the environment using a camera with substantially the same field of view. The same camera may be used, i.e. the first camera 320, such that the first image 260 and the images in the first set of reference images 260′,260″ depict the environment using the same camera having the same field of view. Analogously, the second image 270 and the images in the second set of reference images 270′,270″ depict the environment using a camera with substantially the same field of view. The same camera may be used, such that the second image 270 and the images in the second set of reference images 270′,270″ may depict the environment using the same camera having the same field of view, i.e. using the second camera 330. The first set of reference images 260′,260″ in FIG. 3, e.g. a first video sequence 260′,260″ according to some embodiments, comprises at least two consecutive images captured using the first camera 320 a certain time apart. The at least two consecutive images may be captured by the first camera 320 at a frame rate of 1-250 frames per second.

The second set of reference images 270′,270″, e.g. a second video sequence 270′,270″ according to some embodiments, in FIG. 3 comprises at least two consecutive images captured using the second camera 330 a certain time apart. The at least two consecutive images may be captured by the second camera 330 at a frame rate of 1-250 frames per second.

The positions of the electronic labels 310 within the first set of reference images 260′,260″ may be detected by analyzing the detected temporal pattern of optical changes in the first set of reference images 260′,260″. The positions of the electronic labels 310 within the first set of reference images 260′,260″ may be expressed as coordinates within the set of reference images. The system 300 may determine the positions of the electronic labels 310 in the first image 260 by using the coordinates from the first set of reference images 260′,260″. There may be a known relationship between the first image 260 and the first set of reference images 260′,260″, e.g. a position in the first image 260 may depict a feature which has a known corresponding position in the first set of reference images. The first image may be captured by the same camera or a camera with the same field of view as the camera capturing the first set of reference images. Alternatively, the first image may be captured by a camera with a different field of view compared to the camera capturing the first set of reference images, wherein the difference in field of view between the camera capturing the first image and the camera capturing the first set of reference images is known. Accordingly, the known difference in field of view may be taken into account when determining the position of the electronic label in the first image based on the coordinates from the first set of reference images. The known difference may be taken into account by using a predefined transfer function when determining the position in the first image based on the corresponding position in the first set of reference images.

Accordingly, the positions, i.e. coordinates, of the electronic labels 310 within the first image 260, i.e. the position of the imaged electronic labels 310 within the first image 260, may be detected by analyzing the detected temporal pattern of optical changes in the first set of reference images 260′,260″ which may provide information of the position of the electronic labels 310 within the first image 260.

The positions of the electronic labels 310 within the second set of reference images 270′,270″ may be detected by analyzing the detected temporal pattern of optical changes in the second set of reference images 270′,270″. The positions of the electronic labels 310 within the second set of reference images 270′,270″ may be expressed as coordinates within the set of reference images. The system 300 may determine the positions of the electronic labels 310 in the second image 270 by using the coordinates from the second set of reference images 270′,270″. There may be a known relationship between the second image 270 and the second set of reference images 270′,270″. For example, the second image may be captured by the same camera or a camera with the same field of view as the camera capturing the second set of reference images. Alternatively, the second image may be captured by a camera with a different field of view compared to the camera capturing the second set of reference images, wherein the difference in field of view between the camera capturing the second image and the camera capturing the second set of reference images is known. Accordingly, the known difference in field of view may be taken into account when determining the position of the electronic label in the second image based on the determined position in the second set of reference images. The known difference may be taken into account by using a predefined transfer function when determining the position in the first image based on the corresponding position in the first set of reference images.

Accordingly, the positions, i.e. coordinates, of the electronic labels 310 within the second image 270, i.e. the position of the imaged electronic labels 310 within the second image 270, may be detected by analyzing the detected temporal pattern of optical changes in the second set of reference images 270′,270″ which may provide information on the position of the electronic labels 310 within the second image 270. This may provide the position of electronic labels 310 in the first and second image 260;270, respectively. Hence, the position of the electronic label 310 in the first and second image 260,270, respectively may be determined by analyzing the first and second set reference images. In other words, the system may determine the positions of the electronic labels in the first and second image 260;270 based on the determined positions of the electronic labels in the first and second sets of reference images

The determined positions of the electronic label in the first and second images 260;270 may be used as reference points when stitching the two images together. In other words, the system may stitch the first and second image 260; 270 by using the determined positions of the electronic label in the first and second images 260;270 as reference points.

This may provide the position of the electronic labels 310 in the resulting stitched or combined image after stitching or combining the first and second image 260;270.

Put differently, the system 300 may determine the position of the electronic label in the first and second image 260;270 based on the determined position of the electronic label in the second set of reference images and stitch the first and second image 260,270 by combining the position of the electronic label in the first image with the position of the electronic label in the second image such that the position of the electronic label in the first image align with the position of the electronic label in the second image.

In other words, when the electronic label 310 is arranged within the field of view of both the first and second camera 320, 330, the position of the electronic label 310 in the first and second images 260,270 may be determined based on analysis of the first and second reference images 260′,260″,270′,270″. A first and a second set of coordinates defining the position of the electronic label 310 in said first and second images, respectively may thus be provided.

The determined position of the electronic label 310 in the first image 260 provides a first set of coordinates in the first image 260 defining the position of the electronic label 310 in the first image 260, more specifically, coordinates defining the position of the imaged electronic label 310, i.e. the image of the electronic label 310, within the first image 260. Analogously, the determined position of the electronic label 310 in the second image 270 provides a second set of coordinates in the second image 270 defining the position of the electronic label 310 in the second image 270, more specifically, coordinates defining the position of the imaged electronic label 310, i.e. the image of the electronic label 310, within the second image 270.

The first set of coordinates in the first image defines at least one point in the first image and the second set of coordinates in the second image defines at least one point in the second image, i.e. one point in each of the first and second images 260,270 for each electronic label 310 detected in both the first and second images 260,270. The at least one point in the first image 260 and the at least one point in the second image 270 may be referred to as at least one stitching point in said first and second image 260,270, respectively.

By stitching point it is meant a point depicting the same spatial features in two images, i.e. a point in the first image 260 suitable for overlapping the corresponding stitching point in the second image 270 when combining, i.e. stitching, the first image 260 and the second image 270 together.

In other words, when stitching the first and the second image 260,270, the first set of coordinates in the first image 260, and the second set of coordinates in the second image 270 may serve as a point(s) defined by the first set of coordinates in the first image 260 that may align with point(s) defined by the second set of coordinates in the second image 270. Hence, the provided coordinates in the first and second image 260,270, respectively, may provide at least one point for stitching, i.e. at least one stitching point, in the first and second image 260,270, respectively

Accordingly, the first set of coordinates in the first image 260, and the second set of coordinates in the second image 270 may be used to stitch the first and second image together by overlapping the images such that the point(s) defined by the first set of coordinates in the first image 260 is aligned with the point(s) defined by the second set of coordinates in the second image 270. The first and second set of reference images 260′,260″,270′,270″ may comprise more than two consecutive images as seen in FIG. 3. The images may be captured by the first and second cameras 320;330 at a frame rate of 1-250 frames per second.

The electronic label 310 seen in FIG. 2 and FIGS. 3a-3d is controlled to change its optical output, wherein the changes in optical output of the electronic label include a distinct temporal pattern of optical changes, i.e. the temporal pattern of optical changes is characteristic for a certain electronic label which may facilitate identifying an electronic label in the set of reference images.

The distinct temporal patterns of optical changes in the first and/or second set of reference images 260′;260″;270′;270″ may be detected by analyzing the first and/or second set of reference images 260′;260″;270′;270″.

The first and second sets of reference images 260′,260″,270′,270″ are thus captured by a first and a second camera 320;330 at points in time such that the temporal pattern of optical changes may be detectable in the images in the first and second set of reference images 260′,260″,270′,270″.

The first set of reference images 260′,260″ and the second set of reference images 270′,270″ may each comprise more than two consecutive images in each set, preferably a plurality of consecutive images, captured by the first and second cameras 320,330, respectively. Since, the first set of reference images 260′,260″ and the second set of reference images 270′,270″ may each comprise a plurality of images, the first set of reference images 260′,260″ may be referred to as a first video sequence 260′, 260″ and second set of reference images 270′,270″ may be referred to as a second video sequence 270′,270″. The first set of reference images, 260′,260″ and the second set of reference images may be captured at the same time, in other words, the first and second set of reference images may be captured simultaneously, such that time dependent information may be captured by both the first camera 320 and the second camera 330 and identified in both the first 260′,260″ and second set of reference images 270′,270″.

Information captured by both the first and second cameras 320,330, may for example be spatial features, such as objects in the environment, arranged in the field of view of both the first 320 and the second camera 330, i.e. spatial features depicted by both cameras. This may provide knowledge of coordinates in the first set of reference images and the second set of reference images depicting the same spatial feature(s). Accordingly, a coordinate or several coordinates in the first image, related with the first set of reference images, and the second image, related with the second set of reference images, depicting the same spatial feature(s) may be provided. Time dependent information may for example be the changes in optical output of the electronic label, wherein the changes of optical output of the electronic label 310 may include a temporal pattern of optical changes.

To explain this further, the first set of images 260′,260″ may comprise a set of consecutive images captured one by one in a series, analogously the second set of images 270′,270″ may comprise a set of consecutive images captured one by one in a series. The first captured reference image of the first set of reference images 260′,260″ may be captured at the same time as the first image of the second set of reference images 270′,270″ and the second captured image of the first set of reference images 260′,260″ may be captured at the same time as the second captured image of the second set of reference images 270′,270″ etc. such that time-dependent events viewed by both the first and second cameras 320,330 may be detected, i.e. such that time-dependent events shown in both the first 260′,260″ and second set of reference images 270′,270″ may be detected. By at the same time is here meant that the two set of reference images are captured such that the temporal pattern of optical changes of the electronic label 310 may be detected in both sets of reference images, i.e. the first and second sets of reference images. The frequency of the temporal pattern of optical changes may be lower than the capturing frequency of the set of reference images, hence several captured images in the set of reference images may capture the same optical change and thus the first and second sets of reference images may be shifted in time by several frames and still be able to detect the same optical change. Accordingly, at the same time may be simultaneously or slightly shifted in time such that the temporal pattern of optical changes of the electronic label 310 may be detected in both sets of reference images.

Put differently, there may be a known time shift between capturing the first 260′,260″ and second sets of reference images 270′,270″ which may be taken into account when detecting time-dependent information in both the first and second sets of reference images and thus determining coordinates in each set of reference images depicting the same feature. The images in the set of reference images may be used to distinguish changes in optical output of the electronic label. Since the time-dependent information may be the temporal pattern of optical changes of the electronic label, the capturing of the first set of reference images at the same time as, or with a known time shift relative to, the capturing of the second sets of reference images facilitates distinguishing changes in optical output of the electronic label.

The set of reference images may be captured in a light setting that facilitates distinguishing the change in optical output from the electronic label, i.e. a light setting wherein the visibility of the optical output in relation to the ambient light is enhanced, and accordingly an improvement of the detectability in the changes of optical output may be provided. This could be a light setting wherein the ambient light is relatively dark, for example, the surrounding lights may be switched off or dimmed to a low intensity mode.

With continued reference to FIG. 3a-3d, the distinct temporal patterns of optical changes are detected by analyzing two or more images in the set of reference images.

For example, the electronic label 310 in FIG. 3a-3d is controlled to have its optical output changed in a temporal pattern of optical changes, i.e. the output of the electronic label may be controlled to have its optical output alternated over time, wherein the change in optical output over time is characteristic for a specific electronic label 310.

This change in optical output may be detected, by comparing the images in the first set of reference images 260′,260″ in FIG. 3a and FIG. 3c, to have the position of the electronic label 310 determined in the first set of reference images 260′,260″. Similarly, the change in optical output may be detected, by comparing the images in the second set of reference images 270′,270″ in FIG. 3b and FIG. 3d, to have the position of electronic label 310 determined in the second set of reference images 270′,270″.

By knowing a position in the first set of reference images 260′,260″ that corresponds to a position in the second set of reference images 270′,270″ may facilitate the stitching or combination of an image related to the first set of reference images together with an image related the second set of reference images.

In other words, coordinates in the first set of reference images and coordinates in the second set of reference images may be provided that depicts the same feature in the environment, hence this will be a point suitable to intersect when combining an image related to the first set of reference images with an image related to the second set of reference images. In some embodiments, the images to be stitched together may be extracted from the corresponding set of reference images.

Since the first image 260 is related to the first set of reference images 260′,260″ and the second image 270 is related to the second set of reference images 270′,270″ a stitching or combination of the first image 260 with the second image 270 is facilitated using the information of the position of the electronic label 310 in the first and second set of reference images 260′,260″,270′,270″.

In other words, coordinates in the first image 260 and coordinates in the second image 270 may be provided that correspond to the same feature in the environment. Hence this will be a point suitable to intersect when combining the first and second images 260, 270.

Coordinates in the first set of reference images and coordinate in the second set of reference images may thus be provided that correspond to the same feature in the environment, i.e. the same spatial feature. Hence, this may provide a point in the first image, relating to the first set of reference images, and a point in the second image, relating to the second set of reference images, suitable to align with each other when combining the first and second image. The position of electronic labels 310 located outside the overlapping region may also be determined by analyzing the temporal pattern of optical changes within the first set of reference images 260′;260″ according to the present inventive concept.

A region being viewed by two cameras may be referred to as an overlapping region, i.e. a region within the field of view of two cameras may be referred to as an overlapping region. The electronic labels used to stitch two or more images may be located in the overlapping region of two cameras. In other words, the at least one electronic label arranged to change its optical output in order to determine at least one stitching point in the first and second image, respectively, is arranged in the overlapping region of two cameras.

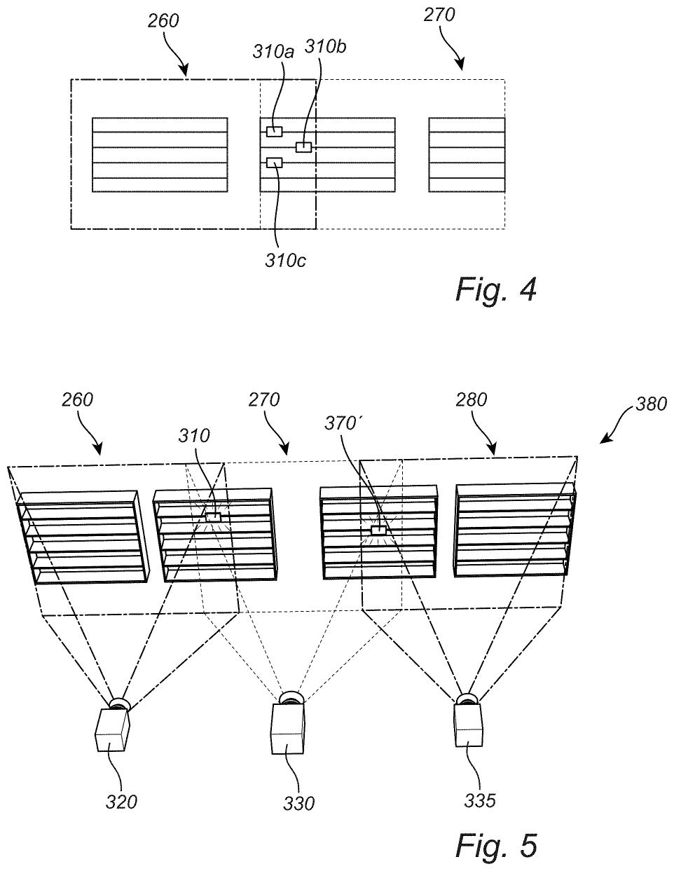

With reference to FIG. 4, three electronic labels 310a-c are illustrated arranged in the overlapping region. However, fewer, such as one or two electronic label(s) 310 may be arranged in the overlapping field of view of the first and second camera 320;330. Alternatively, more than three electronic labels 310 may be arranged in the overlapping region, such as a plurality of electronic labels 310a-c. Accordingly, a plurality of electronic labels 310a-c may be captured by the first and second camera 320;330, i.e. a plurality of electronic labels 310a-c may be arranged in an overlapping field of view of the first and second camera 320;330. This may provide a plurality of points, each having known coordinates in the first image and the second image 260,270 by determining the positions of the electronic labels in the first and second image 260;270 based on the determined positions of the electronic labels in the first and second sets of reference images. The provided coordinates for the plurality of points in the first image 260 and the provided coordinates for the plurality of points in the second image 270 may facilitate the stitching of the first image 260 and the second image 270 by knowing which points to align when stitching, i.e. combining, the first and second image 260,270. In other words, when stitching the first and the second image 260,270, the provided coordinates in the first image 260, and the provided coordinates in the second image 270 may serve as points in the first image 260 that may be aligned with points in the second image 270. Hence, the provided coordinates in the first and second image 260,270, respectively, may provide a plurality of points for stitching, i.e. a plurality of stitching points, in the first and second image 260,270, respectively. Each electronic label 310a-c may be controlled to change its optical output in a temporal pattern of optical changes. The temporal pattern of optical changes from each electronic label 310a-c may be a characteristic for each electronic label 310a-c, such that each electronic label 310a-c may be detected and/or distinguished from other labels. Accordingly, each stitching point in the first image and the second image may be identified and thereby distinguished from each other. By analyzing the first and second set of reference images 260′,260″,270′,270″ each electronic label may be identified, and the position of each electronic label 310a-c may be determined. This may provide a plurality of points that are suitable to intersect, i.e. points that are suitable to align, or be arranged on top of each other, when stitching the images together. In other words, a plurality of coordinates in the first image 260 and a plurality of coordinates in the second image 270 may be provided that correspond to the same features in the environment. Hence, these coordinates may be suitable to intersect/align when combining the first and second images 260, 270.

To further clarify this, the plurality of stitching points in the first image 260 and the second image 270, i.e. points with known coordinates in the first image 260 corresponding to the same spatial feature as also depicted in the second image at known points with known coordinates, may for example comprise three points illustrated as the three electronic labels 310a-310c in FIG. 4. Each electronic label 310a-310c may be identified providing three identified stitching points. The identified point for 310a in the first image 260 may be combined with the identified point 310a in the second image 270, further the identified point for 310b in the first image 260 may be combined with the identified point 310b in the second image 270, and also the identified point for 310c in the first image 260 may be combined with the identified point 310c in the second image 270. By combined it is here meant that the points may be aligned when stitching the two images together.

The first image 260 and second image 270 may be stitched together based on the coordinate or coordinates in the first and second image corresponding to the same spatial feature(s) wherein said coordinates may be determined by analyzing the first and second reference images discussed above.

The first image 260 and the second image 270 may be captured with relatively short time between the capturing of the two images. It may be desirable to have an ambient light in the retail environment with a proper light setting, i.e. normal light setting, wherein the surrounding lights may be switched on when capturing the first and second image. By a proper light setting, i.e. normal light setting it is meant a light setting creating proper visibility of the items in the retail environment, a light setting used for example under opening ours of the retail environment. In other words, the first image 260 and second image 270 may be captured during normal light conditions, wherein the environment is illuminated enough to depict the environment. The first image 260 and second image 270 may thus be captured during the day, for example during opening ours of a retailer, providing updated images of the retail environment during the day. A proper light setting, or a normal light setting, may facilitate depicting objects and or details in the image, such as units of products, type of products, reference object(s), information displayed on the electronic label and other details which are of interest to capture. In other words, the image, e.g. the first image 260 and the second image 270, relating to the set of reference images, e.g. the first set of reference images 260′,260″ and the second set of reference images 270′, 270″, may be captured in an everyday light setting or a light setting with proper illumination, i.e. a light setting that may facilitate the imaging of the environment.

Further, the system 300 may detect obstacles, such as customers or shopping carts, that may be arranged in the image obstructing the view of the shelf or shelf unit, hence the system 300 may request the capturing of a new image.

As a non-limiting example, a customer may be passing by and obstruct the view in only one of the first and second images 260,270, wherein the first image 260 may be captured at time t=0 and the second image may be captured at time t=0+δ and wherein δ may be small, less than one second, preferably within milliseconds or even zero. The customer may obstruct the view of the electronic labels 310a-c and/or products on the shelves in, for example, the second image. This may be detected by the system 300 and the system 300 may subsequently request the capturing of a new second image after a predefined time, T1, i.e. capturing of a second image at time t=0+δ+T. If the system 300 concludes that the newly captured second image 260,270 is fit for stitching, i.e. not having the view of the electronic labels 310a-c and/or products obstructed, the newly captured second image may be stitched together with the first image captured at t=0. Accordingly, the timing of capturing the first and second image are not crucial for stitching the two images together. However, since product units may be removed from the shelves continuously throughout the day a relatively short time between the images that are to be stitched may be desirable, for example, if the captured images are used to indicate an updated inventory list or alert if/when shelves contain a low amount of product units.

The time between the capturing of the set of reference images and the image each set of reference images is relating to, i.e. the image used for stitching, may vary. The first and second images 260, 270 may be captured right after the capture of each respective first and second set of reference images 260′, 260″, 270′, 270″, to which the first and second images 260,270 are related. Alternatively, the image that each set of reference images is related to, e.g. the first and second images 260,270 that are to be stitched together, may be captured at a separate point in time compared to the capture of each respective first and second set of reference images 260′, 260″, 270′, 270″, thus facilitating having different light setting when capturing the set of reference images compared to when capturing the image relating to the set of reference images. In other words, the set of reference images (e.g. the first 260′,260″ and second video sequence 270′,270″) and the related image (e.g. the first 260 and second image 270) may be captured at different times during the day. This may facilitate capturing of the set of reference images (e.g. the video sequence) at one light setting of the ambient light and capturing the image relating to the set of reference images (e.g. the video sequence) at a different light setting of the ambient light.

The electronic label 310a-c may be captured by the first and second cameras 320,330 and may change its optical output. The change in optical output may be a temporal pattern of optical changes. The temporal pattern of optical changes may be characteristic for each electronic label 310a-c in the system 300, such that each electronic label 310a-c may be identified. Further, this may facilitate detecting when two cameras have an overlapping field of view by determining that both cameras depict the same electronic label 310. Further, the detection of the electronic label 310 in the first video sequence 260′,260″ and the second video sequence 270′,270″ may provide coordinates in the first video sequence 260′,260″ and the second video sequence 270′,270″, respectively, depicting the same spatial feature, i.e. the same electronic label 310. The provided coordinates in the first image 260 and the provided coordinated in the second image 270 may facilitate the stitching of the first image 260 and the second image 270 by knowing which points to align when stitching, i.e. combining, the first and second image 260,270. In other words, when stitching the first and the second image, the provided coordinates in the first image 260, and the provided coordinates in the second image 270 serve as a point(s) in the first image 260 that may be aligned with point(s) in the second image 270. Hence, the provided coordinates in the first and second image 260,270, respectively, may provide at least one point for stitching, i.e. at least one stitching point, in the first and second image 260,270, respectively.

To further facilitate the stitching of the first and second image 260,270, a configuration of the first and second cameras 320,330 may be known and/or predetermined, wherein such configuration may comprise zoom-setting, a roll, a pitch and/or a yaw setting of the camera capturing the images, i.e. how the first and second cameras 320,330 are arranged and/or configured with respect to the environment when capturing the images. In other words, the configuration may comprise information on the direction of the field of view and what zoom level is used for the first and second camera 320,330, respectively. Since one electronic label 310 may provide only one stitching point, this stitching point may be combined with the known configuration for the first and second cameras 320,330 when stitching the first and second image together. The configuration of the first and second cameras 320,330 may provide information how the first and second image 260,270 may be adjusted before stitching the two images together by having the stitching point of the first image 260 overlap with the stitching point of the second image 270. By adjusted it may here be meant rotation, skewing and/or adjustment for difference in zoom level of the first and second image 260,270.

In FIG. 4 three electronic labels are seen in the overlapping field of view of the first and second camera 320;330. However, the number of electronic labels 310a-c that may be present in the overlapping field of view of the first and second camera 320;330 is not limited to three electronic labels 310a-c.

By having a plurality of stitching points, i.e. points corresponding to the same spatial features in two images, a facilitated stitching of the first and second image may be provided since the stitching points may indicate points in the first and second image 260,270 being suitable to overlap when stitching the two images together. With increased stitching points the error in the stitching of the images may be reduced, such as a reduced error in alignment of the two stitched images.

In order to properly compensate for differences in zoom-setting between the first and second cameras 320, 330 and consequently alignment errors that may arise due to this when stitching the first and second images 260,270 at least two stitching point may be desirable, i.e. at least two electronic labels 310a-c may be viewed by both the first and second camera 320,330, which means that at least two electronic labels 310a-c may be arranged in the area where the field of view of the first camera 320 overlaps with the field of view of the second camera 330.

In order to properly compensate for differences in roll, tilt and/or yaw between the first and second cameras 320, 330 and consequently for alignment errors that may arise due to this when stitching the first and second images 260,270, at least three stitching points may be desirable, i.e. at least three electronic labels 310a-c may be viewed by both the first and second camera 320,330, which means that at least three electronic labels 310a-c may be arranged in the area where the field of view of the first camera 320 overlap with the field of view of the second camera 330.

Consequently, at least one of the camera setting and the camera orientation may be determined and/or be predetermined in combination with having only one or two electronic labels 310a-c arranged in the area where the field of view of the first camera 320 overlaps with the field of view of the second camera 330, that may provide only one or two stitching points. There may be a plurality of cameras capturing images. As seen in FIG. 5, a third camera 335 may be present for capturing a third image 280 and a third set of reference images. The third set of reference images may be related to the third image 280, i.e. the third image 280 and the third set of reference images are captured using the third camera 335. A second electronic label 370 may be present within the field of view of the third camera 335. Hence, the second electronic label 370 may be present in the third set of reference images. The second electronic label 370 may be present withing the field of view of the second camera 330. Hence, the second electronic label 370 may be present in the second set of reference images 270′,270″. The third camera 335 may have a field of view that overlaps with the field of view of the second camera 330. The second electronic label 370 may be located in the field of view of the second and third camera 330,335, i.e. the second electronic label 370 may be located in an overlapping field of view of the second and third camera 330;335.

The third set of reference images may comprise at least two images, the third set of reference images may comprise a plurality of images similar to the first and second set of reference images 260′,260″,270′,270″. Additionally, the time when to capture the third set of reference images in relation to the capturing of the second set of reference images may be determined in the same manner as was explained above for the capture of the first and second set of reference images. In other words, the third set of reference image may be captured at the same time as the second set of reference images in order to detect the temporal pattern of optical changes from the electronic label in both sets of images, i.e. the second and third set of reference images.

Similar to the determining of the position of the first electronic label 310 in the first and second images 260;270, the position of the second electronic label 370 may be determined in the second and third images 270;280.

Similar to the combination or stitching of the first and second image 260;270 using the first and second set of reference images 260′,260″;270′,270″, the second and third images 270;280 may be combined or stitched together using the second and third set of reference images.

The first 260, second 270 and third images 280 may be stitched together into one resulting image 380.

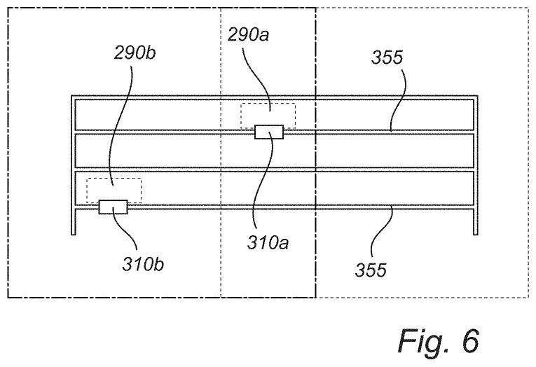

With reference to FIG. 6, an item 290a may be associated with the electronic label 310a. Further, an item 290b may be associated with the electronic label 310b. The item 290a associated with the electronic label 310a may be arranged on the same shelf unit 350 or on the same single shelf 355 as the electronic label 310a is arranged. The item 290b associated with the electronic label 310b may be arranged on the same shelf unit 350 or on the same single shelf 355 as the electronic label 310b is arranged. By determining the position of the electronic label 310a and/or 310b in the image, the position of an associated item 290a and/or 290b may indirectly be determined.

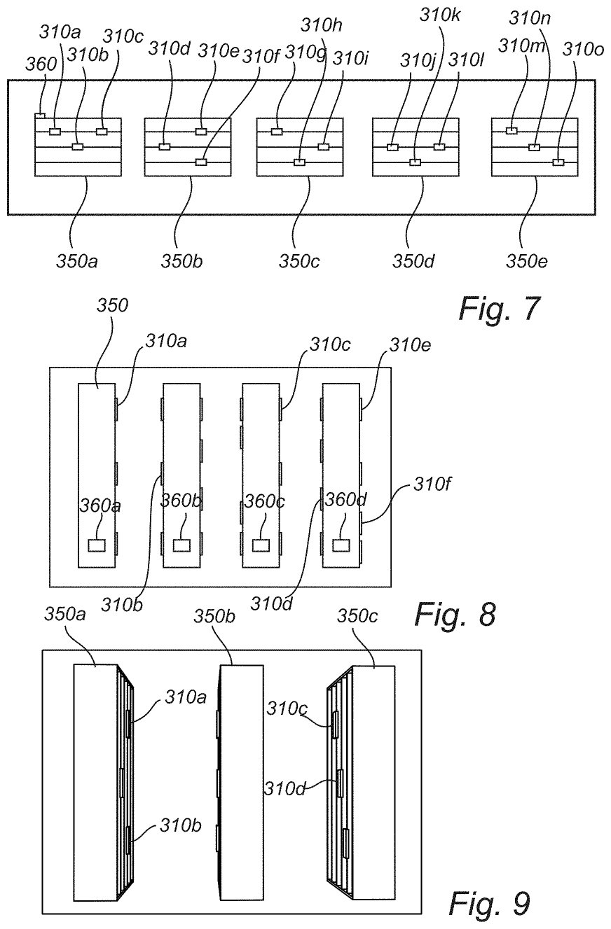

With reference to FIG. 7, a 2D map may be generated based on the stitched or combined images. The generated 2D map may be referred to as a 2D side map. The generated 2D map may depict the shelf units 350a-e from the side. The first and second image 260;270 may be stitched or combined as previously described. This may be repeated for a third image 280 as previously discussed. This may be iterated a plurality of times to stitch a plurality of images together. With increasing number of images stitched together, the resulting image after stitching or combining may be larger. The resulting image may depict a field of view comparable to a combined field of view of all the cameras used. The reference object 360 seen in FIG. 7 may have a known position. The reference object 360 may be present in at least one of the images being combined or stitched together. This may provide information on relative and/or absolute position of details in the image, such as the electronic labels 310a-o and/or associated items 390.

The reference object 360 with a known position may be used to determine the position of the camera capturing the image of the reference object 360. By locating the reference object in an image, the camera position may be determined. The reference object 360 may contain information facilitating identification of the reference object 360, such as a QR-code, a symbol, a number and/or letter. The reference object 360 may contain system information, such as the object position and/or location of nearby cameras. More than one reference object 360 may be present in an image facilitating determination of camera position. More than one reference object 360 may be present in a set of stitched images. Determined positions of electronic labels captured by the camera may be used to determine the camera position. based on a known focal length of the camera combined with points in a captured image with known positions, the camera position may be determined.

FIG. 8 shows a 2D map of a plurality of shelf units 350. With reference to FIG. 8, a 2D map may be generated based on the stitched or combined images. The generated 2D map may be referred to as a 2D top view map. At least one reference object 360a-d with known position may be present in order to determine absolute and/or relative position of the electronic labels 310a-f in the plurality of shelf units 350. The 2D top view map may be generated based on the determined absolute and/or relative position of the electronic labels 310a-f in the plurality of shelf units 350.

FIG. 9 shows a 3D map over a plurality of shelf units 350a-c. Based on the determined position of the electronic labels 310a-d, a 3D map may be created. Creating the 3D map may use the information from at least one reference object 360.

In the above embodiments, to determine an absolute position of an electronic label 310a-d, a relative position of the electronic label may be determined relative another electronic label 310a-d and/or a reference object 360. Consequently, an absolute position of the electronic label 310a-d may be determined based on a known position of the reference object 360 and/or the another electronic label 310a-d.

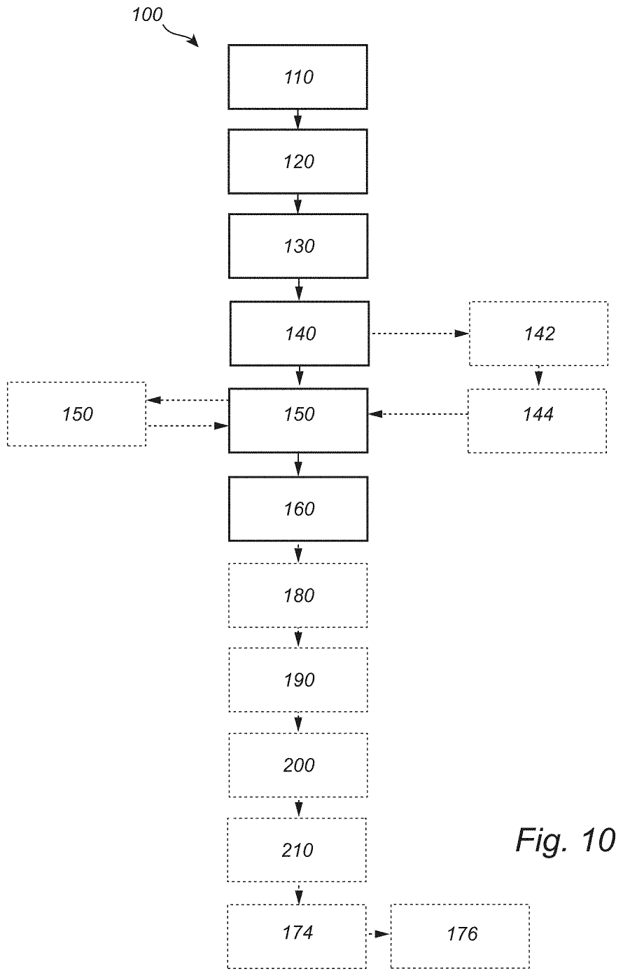

A method 100 for stitching images of a retail environment by stitching a first image and a second image according to an embodiment will be described with reference to FIG. 10. The first image and the second image each comprises an electronic label having an optical output, and the method comprises controlling 110 the electronic label to change its optical output, wherein the changes of optical output of the electronic label include a temporal pattern of optical changes, and receiving 120 a first set of reference images related to the first image, the images in the first set of reference images comprising the electronic label and captured by a first camera at points in time such that the temporal pattern of optical changes is detectable in the images in the first set of reference images. The method further comprises determining 130 the position of the electronic label in the images in the first set of reference images based on a detected temporal pattern of optical changes and receiving 140 a second set of reference images related to the second image, the images in the second set of reference images comprising the electronic label and captured by a second camera at points in time such that the temporal pattern of optical changes is detectable in the images in the second set of reference images. The method further comprises determining 150 the position of the electronic label in the images in the second set of reference images based on a detected temporal pattern of optical changes, and determining 155 the positions of the electronic label in the first and second images 260;270 based on the determined 130,150 position of the electronic label in the first and second sets of reference images. Further, the method may comprise stitching 160 the first and second images based on the position of the electronic label in the first and second sets of reference images. The position of the electronic label in the first image may thus be aligned with the position of the electronic label in the second image such that a stitched, i.e. combined image is achieved.

The first image 260 may be captured with a camera having the same field of view as the camera capturing the first set of reference images. Alternatively, the first image 260 may be captured with a camera having a different field of view, wherein the difference in field of view between the camera capturing the first image 260 and the first set of reference images 260′,260″ may be known. Accordingly, the first image 260 may be captured by the first camera 320. The first camera 260 may have the same field of view compared to when capturing the first set of reference images 260′,260″ or the first camera 260 may have a changed field of view compared to when capturing the first set of reference images 260′,260″, wherein the changed field of view may be known. As an alternative to capturing the first image 260 using the first camera 320, an auxiliary camera may be used wherein the field of view of the auxiliary camera may be different from the field of view of the first camera 320, wherein this difference in field of view is known.

The second image 270 may be captured with a camera having the same field of view as the camera capturing the second set of reference images. Alternatively, the second image 270 may be captured with a camera having a different field of view, wherein the difference in field of view between the camera capturing the second image 270 and the second set of reference images 270′,270″ may be known. Accordingly, the second image 270 may be captured by the second camera 330. The second camera 270 may have the same field of view compared to when capturing the second set of reference images 270′,270″ or the second camera 270 may have a changed field of view compared to when capturing the second set of reference images 270′,270″, wherein the changed field of view may be known. As an alternative to capturing the second image 270 using the second camera 320 an auxiliary camera may be used wherein the field of view of the auxiliary camera may be different from the field of view of the second camera 330, wherein this difference in field of view is known.

As a non-limiting example, settings for the first and second cameras 320,330, may be changed between the capturing of the first and second set of reference images and the capturing of the first and second images, wherein the change in settings of the first and second cameras may be known and may comprise at least one of a change in roll, tilt, yaw and zoom. The changed setting between capturing of the first set of reference images and the first image and between capturing of the second set of reference images and the second image may be taken into account when determining the position of the electronic labels in the first and second image based on the position of the electronic labels in the first and second sets of reference images, respectively.

The optical output of, or from, the electronic label may change over time. This change may be characteristic for a certain electronic label and hence, the electronic label may then be identified in succeeding method steps of receiving a first and a second set of reference images. As previously mentioned, the output may be of different colors and/or the output may have a varied frequency from a fast blinking or flashing light to a slow blinking or pulsating light.

The first set of reference images may be captured by a first camera and subsequently received 120 such that the temporal pattern may be detectable in the images.

The second set of reference images may be captured by a second camera and subsequently received 140 such that the temporal pattern may be detectable in the images.

As an example, a fast blinking light of optical output from the electronic label may be that the output of the display may be altered and thus distinguished between two subsequent recorded images of the label. Slow may be referring to that the output of the display may be changed so that the change in output may be distinguishable after a plurality of frames of the recoding, for example more than 50 frames. Hence, the term slow or fast may be determined in relation to the camera used and its frames per second during recording. A camera working in the range between 1 to 250 frames per second (fps) may be used. The change of optical output of the label may combine different lengths and/or color of blinking so that a pattern characteristic for a specific label is achieved when recording images of the label. A fast blinking may be used such that a difference in output is detectable in for example less than 10 frames. Two cameras may view the same set of electronic labels and a fast blinking may facilitate determining that they view the same temporal pattern. The two cameras may be synchronized such that they capture images simultaneously, in other words, the cameras may be timed together. If the two cameras are synchronized this may facilitate that the two cameras are viewing and/or capturing the same temporal pattern. Any option in between the slow and fast change of optical output may be used, i.e. a change in optical output distinguishable in a couple of frames to hundreds of frames may be utilized. The change in optical output may be timed with the image recording. A control signal may trigger the image capturing and the change in optical output in order to adapt the change in optical output to the capturing of images with the cameras.

By comparing the optical output to a known pattern, the electronic label may be identified and its position determined. A period may be one on and off cycle of the optical output of the electronic label.

Several periods of optical outputs of the electronic label may detected and used to determine the position of the electronic label. The optical output may be compared to a known pattern, timing, and/or color scheme in order to detect a certain electronic label.

A single period or pulse of optical output of the electronic label may be detected and used to determine the position of the electronic label. The optical output may be compared to known points in time and/or a known color scheme. For example, blue may be significant for electronic label 1, green may be significant for electronic label 2 etc. In another example blue at time t1 may be significant for electronic label 3, green at time t2 may be significant for electronic label 4 etc. In yet another example, detected light at t1 may be significant for electronic label 5, detected light at t2 may be significant for electronic label 6 etc.

By knowing the position of the electronic label in the first image and the position of the electronic label in the second image, information is given on points in the first and second image suitable to be joined when stitching the images together. This point may determine how to stitch images together or be used as input to a second algorithm relying on image processing to stitch the two images together.

With continued reference to FIG. 10, the method may also comprise detecting 142 the distinct temporal patterns of optical changes in the in the first set of reference images by analyzing the first set of reference images and detecting 144 the distinct temporal patterns of optical changes in the in the second set of reference images by analyzing the second set of reference images, wherein the determining 130; 150 of the position of the electronic label in the images is based on the detected distinct temporal patterns of optical changes in the respective first and second set of reference images.

The detection of temporal patterns of optical changes may be done by comparing the images in the set of reference images. The detection could comprise any of subtraction or division between two or more consecutive images in order to determine the changes in one image to another. The images compared may be two or more directly consecutive images or two or more images that are more than one image apart. The detection of distinct temporal patterns of optical changes could be done in any way known within the field of image detection and will not be discussed further.

Also seen in FIG. 10, the method may comprise determining 170 that the electronic label in said first set of reference images is the same as the electronic label in said second set of reference images, wherein the determining 170 is based on the distinct temporal patterns of optical changes in said first and second set of reference images indicating that the patterns originate from the same electronic label.

The electronic label may be associated with an item and the determined position of the electronic label may then be associated with a position of that item.

With continued reference to FIG. 10 the method may comprise determining 174 the position of said first camera based on the first image or determining 176 the position of said second camera based on the second image.

The determination 174;176 of the position of said first or second camera may be based on a reference object comprised in the first or second image.

With continued reference to FIG. 10, the method may comprise generating 180 a map over at least a portion of the retail environment based on the stitched images and the determined position of the electronic label.

The map may be generated based on a reference object comprised in the first or second image. The reference object may be present in relation to or associated with a shelf and/or section of the retail environment. This may facilitate the creation of maps over the retail environment. The map may be used to facilitate for users to navigate through the retail environment and help find the correct products.

The generated map may be a three-dimensional map. The 3D map may be viewed by a user and used by the user to navigate through the retail environment.

The controlling of the electronic label may be performed in response to a first control signal from a processing unit and the images are captured by said first or second camera in response to a second control signal from the processing unit. The control signal may trigger the image capturing and the change in optical output so that the timing of change in optical output will adapted to the capturing of images with the cameras.

The second image comprises a second electronic label and a third image may comprise the second electronic label, and the method may further comprise receiving 190 a third set of reference images related to the third image, the images in the third set of reference images comprising the second electronic label and captured by a third camera at points in time such that a second temporal pattern of optical changes is detectable in the images in the third set of reference images,

determining 200 the position of the second electronic label in the images in the second set of reference images based on a detected temporal pattern of optical changes, and determining 202 the position of the second electronic label in the images in the third set of reference images based on a detected temporal pattern of optical changes, and stitching 208 the third image with the second image by using the determined 204 positions of the electronic label in the second and third images as reference points.

As previously discussed, by knowing the position of the electronic label in the first image and the position of the electronic label in the second image, information is given on points in the first and second image suitable to intersect/align, i.e. a point in the first and the second image depicting the same electronic label, when stitching the images together. This point may be input to a second algorithm relying on image processing to determine suitable stitching in order to increase the efficiency or this may by itself be used as the algorithm to stitch the images together.

Obviously, the same applies for the second and third set of reference images and their respective related images.

A region being viewed by two cameras may be referred to as an overlapping region, in other words the overlapping region is the region where two cameras share their field of view, in other words the region where the two cameras has an overlapping field of view is called an overlapping region. The electronic labels used to stitch two or more images may be located in the overlapping region of two cameras.

The method 100 may comprise more than one electronic label 310 in the overlapping region. In other words, the method 100 may comprise more than one electronic label 310 viewed by both the first and second camera 330;330.

More than one electronic label may be used to provide additional intersecting points to further facilitate the stitching of the images.

It should be understood that using a plurality of electronic labels in order to stitch two images, is covered within the inventive concept described above.

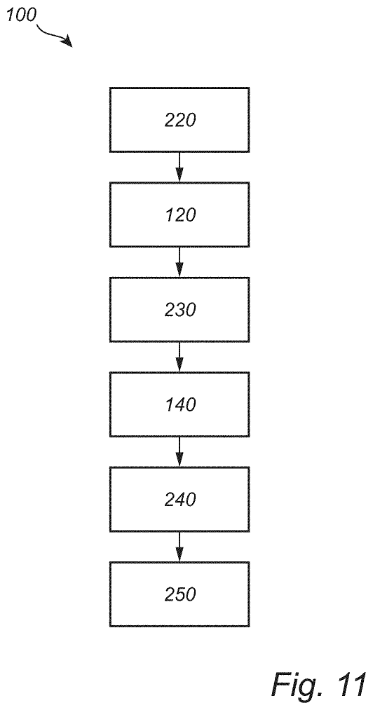

For clarity purposes only, the method is further discussed with reference to FIG. 11 using a plurality of electronic labels.

The method may be similarly configured as the method described with reference to FIG. 10, but the method comprises a plurality of electronic labels.

With reference to FIG. 11, the first image and the second image may comprise a plurality of electronic labels, and the first and the second set of reference images received may comprise the electronic labels, and the method 100 may comprise controlling 220 the electronic labels to change their respective optical output, wherein the respective changes of optical output of the electronic labels include a temporal pattern of optical changes.

It should be understood that the step of controlling 220 is corresponding to the step of controlling 110, performed for the plurality of electronic labels.

The method may further comprise receiving 120 a first set of reference images related to the first image, the images in the first set of reference images comprising the electronic label and captured by a first camera at points in time such that the temporal pattern of optical changes is detectable in the images in the first set of reference images, and determining 230 the respective positions of the electronic labels in the images in the first set of reference images based on a detected temporal pattern of optical changes.

It should be understood that the step of determining 230 corresponds to the step of determining 130, performed for the plurality of electronic labels.

The method may further comprise receiving 140 a second set of reference images related to the second image, the images in the second set of reference images comprising the electronic label and captured by a second camera at points in time such that the temporal pattern of optical changes is detectable in the images in the second set of reference images, determining 240 the respective positions of the electronic labels in the images in the second set of reference images based on a detected temporal pattern of optical changes, and determining 245 the position of the electronic labels in the first and second images based on the determined 230,240 positions of the electronic labels in the first and second sets of reference images.

It should be understood that the steps of determining 240 and determining 245 corresponds to the steps of determining 150 and determining 155, but performed for the plurality of electronic labels.

The method may further comprise stitching 250 the first and second images by using the determined 150,155 positions of the electronic label in the first and second images 260;270 as reference points.

It should be understood that the step of stitching 250 corresponds to the steps of stitching 160, but performed for the plurality of electronic labels.

The person skilled in the art realizes that the present invention is by no means limited to the preferred embodiments described above. On the contrary, many modifications and variations are possible within the scope of the appended claims.

Additionally, variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The division of tasks between functional units referred to in the present disclosure does not necessarily correspond to the division into physical units; to the contrary, one physical component may have multiple functionalities, and one task may be carried out in a distributed fashion, by several physical components in cooperation. A computer program may be stored/distributed on a suitable medium, such as an optical storage medium or a solid-state medium supplied together with or as part of other hardware, but may also be distributed in other forms, such as via the Internet or other wired or wireless telecommunication systems. The mere fact that certain measures are recited in mutually different dependent claims does not indicate that a combination of these measures cannot be used to advantage. Any reference signs in the claims should not be construed as limiting the scope.

1. A method for stitching together a first image and a second image of a retail environment, wherein the first image and the second image each comprises an electronic label having an optical output, the method comprising:
controlling the electronic label to change its optical output, wherein the changes of optical output of the electronic label include a temporal pattern of optical changes;
receiving a first set of reference images related to the first image, the images in the first set of reference images comprising the electronic label and being captured by a first camera at points in time such that the temporal pattern of optical changes is detectable in the images in the first set of reference images;
determining the position of the electronic label in the images in the first set of reference images based on a detected temporal pattern of optical changes;
receiving a second set of reference images related to the second image the images in the second set of reference images comprising the electronic label and being captured by a second camera at points in time such that the temporal pattern of optical changes is detectable in the images in the second set of reference images;
determining the position of the electronic label in the images in the second set of reference images based on a detected temporal pattern of optical changes;
determining, the position of the electronic label in the first and second images based on the determined position of the electronic label in the first and second sets of reference images;
stitching the first and second image by using the determined positions of the electronic label in the first and second images as reference points.

2. The method according to claim 1, wherein the method comprises;
detecting the distinct temporal patterns of optical changes in the in the first set of reference images by analyzing the first set of reference images;
detecting the distinct temporal patterns of optical changes in the in the second set of reference images by analyzing the second set of reference images;
wherein the determining of the position of the electronic label in the first and second sets of reference images is based on the detected distinct temporal patterns of optical changes in the respective first and second set of reference images.

3. The method according claim 1, wherein the method comprises;
determining that the electronic label in said first set of reference images is the same as the electronic label in said second set of reference images,
wherein the determining is based on the distinct temporal patterns of optical changes in said first and second set of reference images indicating that the patterns originate from the same electronic label.

4. The method according to claim 1 wherein the electronic label is associated with an item and wherein the determined position of the electronic label is associated with a position of said item.

5. The method according to further comprising:
determining the position of said first camera based on the first image; or
determining the position of said second camera based on the second image.

6. The method according to claim 5, wherein the determination of the position of said first or second camera is based on a reference object comprised in the first or second image.

7. The method according to claim 5, wherein the first image is captured by the first camera and the second image is captured by the second camera.

8. The method according to claim 5 wherein the method comprises;
generating a map over at least a portion of the retail environment based on the stitched images and the determined position of the electronic label.

9. The method according to claim 8, wherein the map is generated based on a reference object comprised in the first or second image.

10. The method according to claim 8, wherein the generated map is a three-dimensional map.

11. The method according to claim 8 wherein the controlling of the electronic label is performed in response to a first control signal from a processing unit and the images are captured by said first or second camera in response to a second control signal from the processing unit.

12. The method according to claim 8, wherein the second image comprises a second electronic label and a third image comprises the second electronic label, the method further comprising;
receiving a third set of reference images related to the third image, the images in the third set of reference images comprising the second electronic label and captured by a third camera points in time such that a second temporal pattern of optical changes is detectable in the images in the third set of reference images;
determining the position of the second electronic label in the images in the second set of reference images based on a detected temporal pattern of optical changes;
determining the position of the second electronic label in the images in the third set of reference images based on a detected temporal pattern of optical changes;
determining the position of the electronic label in the second and third images based on the determined position of the electronic label in the second and third sets of reference images;
stitching the third image with the second image by using the determined positions of the electronic label in the second and third images as reference points.

13. The method according to claim 8, wherein the first image and the second image comprises a plurality of electronic labels, and wherein the first and the second set of reference images received comprises the electronic labels; the method further comprising:
controlling the electronic labels to change their respective optical output, wherein the respective changes of optical output of the electronic labels include a temporal pattern of optical changes;
determining the respective positions of the electronic labels in the images in the first set of reference images based on a detected temporal pattern of optical changes;
determining the respective positions of the electronic labels in the images in the second set of reference images based on a detected temporal pattern of optical changes;
determining the position of the electronic labels in the first and second image based on the determined of the electronic labels in the first and second sets of reference images;
stitching the first and second image by using the determined positions of the electronic labels in the first and second images as reference points.

14. A system stitching images, wherein the system comprises:
an electronic label arranged to change its optical output;
a first camera capturing a first set of reference images comprising the electronic label;
a second camera for capturing a second set of reference images comprising the electronic label;
a processing unit for performing the method according to claim 8.

15. The system according to claim 14, wherein the electronic label arranged on a shelf.

16. The system according to claim 14, wherein the first camera is arranged on a first shelf and the second camera is arranged on a second shelf.

17. The system according to claim 14, wherein the system comprises a reference object associated with a shelf.
